(19) United States
(12) Patent Application Publication
(10) Pub. No.: US 2024/0353908 A1
(43) Pub. Date: Oct. 24, 2024

(54) POWER MANAGEMENT METHOD

(71) Applicant: Mitac Computing Technology Corporation, Taoyuan City (TW)

(72) Inventors: Lung-Chiao CHANG, Taoyuan City (TW); Fu-Chieh CHANG, Taoyuan City (TW); Ming-Shou SHEN, Taoyuan City (TW)

(73) Assignee: Mitac Computing Technology Corporation, Taoyuan City (TW)

(21) Appl. No.: 18/617,254

(22) Filed: Mar. 26, 2024

(30) Foreign Application Priority Data
Apr. 20, 2023 (TW) 112114757

(51) Int. Cl. G06F 1/30; G06F 1/26

(52) U.S. Cl. CPC G06F 1/30; G06F 1/263

(57) ABSTRACT

A power management method is adapted for a computer system that includes a CPU, a control unit, a BIOS and multiple PSUs. When one PSU operates abnormally, it sends an alert signal that is in an alert state to the control unit, and the control unit causes the CPU to operate under a predefined lowest power consumption limit. The control unit computes an updated power consumption limit, and notifies the BIOS to write the updated power consumption limit into a model-specific register of the CPU, so as to make the CPU operate under the updated power consumption limit.

### CROSS-REFERENCE TO RELATED APPLICATION

This application claims priority to Taiwanese Invention Patent Application No. 112114757, filed on Apr. 20, 2023, and incorporated by reference herein in its entirety.

### FIELD

The disclosure relates to a power management method of a computer system, and more particularly to a power management method for flexibly adjusting power consumption of a central processing unit (CPU) when a power supply unit (PSU) operates abnormally.

### BACKGROUND

A conventional computer system includes a central processing unit (CPU), a baseboard management controller (BMC), and a power supply unit (PSU). When the PSU itself has detected abnormal conditions, such as output voltage exceeding a predefined range, a malfunction in a cooling fan, excessively high temperature, excessive output current, excessively high output voltage, excessively low input voltage, etc., the PSU sends an alert signal (usually called SMBALERT) to the BMC, prompting the BMC to send a throttling signal to the CPU, which in turn causes the CPU to operate in a throttling state under restriction of a predefined lowest power consumption limit. However, when the CPU operates in the throttling state for an unnecessarily long period of time, it can lead to a significant decrease in system performance, causing the system to become unresponsive.

### SUMMARY

Therefore, an object of the disclosure is to provide a power management method that can flexibly adjust power consumption of the CPU when the PSU operates abnormally.

According to some embodiments of the disclosure, the power management method is adapted for a computer system that includes a CPU, a control unit, a basic input/output system (BIOS), and multiple PSUs that include a first PSU. The power management method includes steps of: A) when the first PSU operates in a predefined abnormal condition, the first PSU changing an alert signal, which is sent by the first PSU to the control unit, from a non-alert state to an alert state; B) when detecting the change of the alert signal from the non-alert state to the alert state, the control unit changing a throttling signal, which is sent by the control unit to the CPU, from a non-throttling state to a throttling state, so that the CPU operates under restriction of a predefined lowest power consumption limit; C) when detecting the change of the alert signal from the non-alert state to the alert state, the control unit computing and sending, based on one of a maximum output power value of the first PSU and a total maximum output power value of the PSU(s) other than the first PSU, an updated power consumption limit that is greater than the predefined lowest power consumption limit to the BIOS; D) when receiving the updated power consumption limit, the BIOS outputting a first system management interrupt to the CPU, and writing the updated power consumption limit into a model-specific register of the CPU; and E) after step D), the BIOS notifying the control unit to change the throttling signal from the throttling state to the non-throttling state, so that the CPU operates under restriction of the updated power consumption limit according to the model-specific register.

According to some embodiments of the disclosure, the power management method is adapted for a computer system that includes a CPU, a control unit, a BIOS, and multiple PSUs that include a first PSU. Each of the PSUs sends an alert signal to the control unit and the BIOS. The power management method includes steps of: A) when the first PSU operates in a predefined abnormal condition, the first PSU changing the alert signal sent thereby from a non-alert state to an alert state; B) when detecting the change of the alert signal sent by the first PSU from the non-alert state to the alert state, the control unit changing a throttling signal, which is sent by the control unit to the CPU, from a non-throttling state to a throttling state, so that the CPU operates under restrictions of a predefined lowest power consumption limit; C) when detecting the change of the alert signal sent by the first PSU from the non-alert state to the alert state, the BIOS computing, based on one of a maximum output power value of the first PSU and a total maximum output power value of the PSU(s) other than the first PSU, an updated power consumption limit that is greater than the predefined lowest power consumption limit to the BIOS; D) the BIOS outputting a first system management interrupt to the CPU, and writing the updated power consumption limit into a model-specific register of the CPU; and E) after step D), the BIOS changing a notification signal, which is sent by the BIOS to the control unit, from a non-notification state to a notification state, so that the control unit changes the throttling signal from the throttling state to the non-throttling state, and that the CPU operates under restriction of the updated power consumption limit according to the model-specific register.

According to some embodiments of the disclosure, the power management method is adapted for a computer system that includes a CPU, an operating module, and multiple PSUs that include a first PSU. Each of the PSUs sends an alert signal to the operating module. The power management method includes steps of: A) when the first PSU operates in a predefined abnormal condition, the first PSU changing the alert signal sent thereby from a non-alert state to an alert state; B) when detecting the change of the alert signal sent by the first PSU from the non-alert state to the alert state, the operating module changing a throttling signal, which is sent by the operating module to the CPU, from a non-throttling state to a throttling state, so that the CPU operates under restriction of a predefined lowest power consumption limit; C) when detecting the change of the alert signal sent by the first PSU from the non-alert state to the alert state, the operating module computing, based on one of a maximum output power value of the first PSU and a total maximum output power value of the PSU(s) other than the first PSU, an updated power consumption limit that is greater than the predefined lowest power consumption limit; D) the operating module outputting a first system management interrupt to the CPU, and writing the updated power consumption limit into a model-specific register of the CPU; and E) after step D), the operating module changing the throttling signal from the throttling state to the non-throttling state, so that the CPU operates under restriction of the updated power consumption limit according to the model-specific register.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a computer system that is adapted to implement a first embodiment of a power management method according to the disclosure.

FIG. 2 is a flow chart illustrating steps of the first embodiment of the power management method.

FIG. 3 is a block diagram illustrating a computer system that is adapted to implement a second embodiment of a power management method according to the disclosure.

FIG. 4 is a flow chart illustrating steps of the second embodiment of the power management method.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

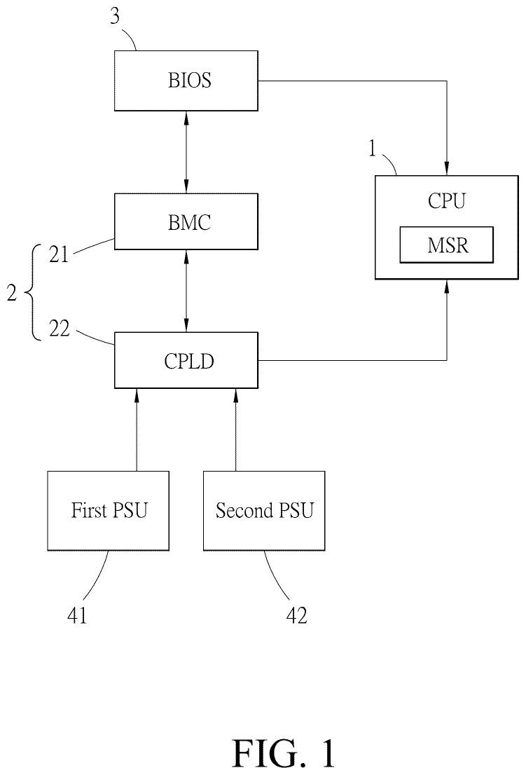

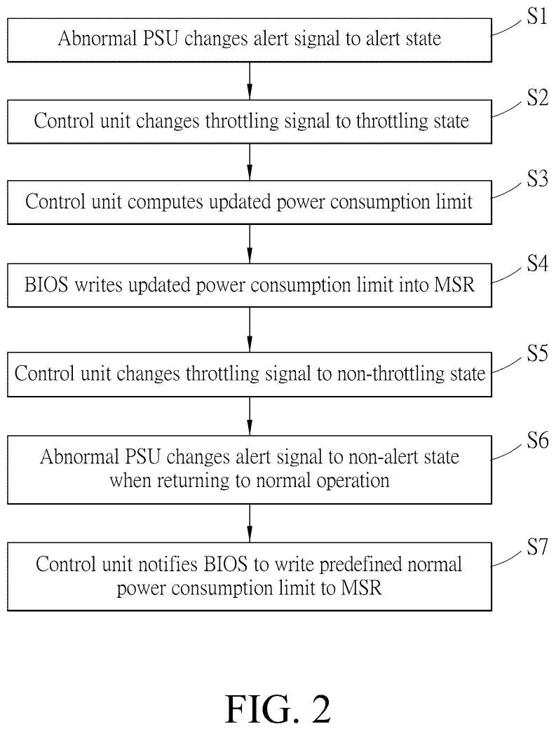

Referring to FIGS. 1 and 2, a first embodiment of a power management method according to this disclosure is adapted for a first computer system that includes a central processing unit (CPU) 1, a control unit 2, a basic input/output system (BIOS) 3, and a plurality of power supply units (PSUs). In this embodiment, the control unit 2 includes a baseboard management controller (BMC) 21 and a complex programmable logic device (CPLD) 22, and the PSUs include a first PSU 41 and a second PSU 42. In other embodiments, the first computer system may include more than two PSUs. In some embodiments, the control unit 2 and the BIOS 3 may be collectively considered as an operating module.

In step S1, each of the PSUs 41, 42 performs self-detection to determine whether the PSU itself operates in a predefined abnormal condition, and sends an alert signal (e.g., SMBALERT) that signifies a detection result to the CPLD 22. The predefined abnormal condition may be, for example but not limited to, output voltage exceeding a predefined range, a malfunction in a cooling fan, excessively high temperature, excessive output current, excessively high output voltage, excessively low input voltage, etc. For each of the PSUs 41, 42, when itself has detected that it operates in the predefined abnormal condition, it changes the alert signal from a non-alert state (e.g., logic 1 or logic 0) to an alert state (e.g., logic 0 or logic 1, which is different from the non-alert state). Hereinafter, for ease of description, the first PSU 41 is exemplified to be the PSU that has detected that it operates in the predefined abnormal condition.

In step S2, the CPLD 22 detects the alert signals received from the PSUs 41, 42, and changes a throttling signal, which is sent by the CPLD 22 to the CPU 1, from a non-throttling state (e.g., logic 1 or logic 0) to a throttling state (e.g., logic 0 or logic 1, which is different from the non-throttling state) when detecting the change of the alert signal sent by the first PSU 41 from the non-alert state to the alert state, so that the CPU 1 operates under restriction of a predefined lowest power consumption limit (i.e., operating in a throttling state, in which the power consumption of the CPU 1 is at most equal to the predefined lowest power consumption limit) upon detecting that the throttling signal is in the throttling state. The predefined lowest power consumption limit is a lowest one of a plurality of predefined power consumption limits. The CPLD 22 may further notify the BMC 21 that the alert signal has changed to the alert state.

In step S3, the BMC 21 computes an updated power consumption limit based on one of a maximum output power value of the first PSU 41 and a total maximum output power value of the PSU(s) other than the first PSU 41 (e.g., the maximum output power value of the second PSU 42 in this embodiment), and sends the updated power consumption limit to the BIOS 3, where the updated power consumption limit is greater than the predefined lowest power consumption limit.

In a first implementation of computing the updated power consumption limit, the first computer system has a plurality of power differentials stored in a non-volatile memory component (not shown) that is accessible to the BMC 21. The power differentials respectively correspond to different single-PSU normal maximum output power values for a single PSU, where each of the power differentials represents a presumed excess of a maximum power consumption value of the first computer system over a total maximum output power value of the remaining PSU or PSUs other than the single PSU to which the power differential corresponds (i.e., the remaining PSU or PSUs that operate normally when said single PSU is abnormal. Based on a normal maximum output power value of the first PSU 41, the BMC 21 determines one of the power differentials that corresponds to the first PSU 41 (i.e., the single-PSU normal maximum output power value that corresponds to said one of the power differentials is equal to the normal maximum output power value of the first PSU 41), and obtains the updated power consumption limit by subtracting the power differential thus determined from a predefined normal (or greatest) power consumption limit of the CPU 1, which is a greatest one of the plurality of predefined power consumption limits. For instance, in a case where the power differential that corresponds to the normal maximum output power value of the first PSU 41 is 200 W, and the predefined normal power consumption limit of the CPU 1 is 600 W, the updated power consumption limit would be 600 W−200 W=400 W.

In a second implementation of computing the updated power consumption limit, the BMC 21 subtracts the maximum power consumption value of the first computer system from the total maximum output power value of the remaining PSU or PSUs that operate normally (i.e., the PSU(s) other than the first PSU 41) to obtain a power differential, and adds up the power differential and the predefined normal power consumption limit of the CPU 1 to obtain the updated power consumption limit when the power differential is smaller than zero (i.e., the maximum power consumption value of the first computer system being greater than the total maximum output power value of the remaining PSU or PSUs that operate normally). For instance, in a case where the maximum power consumption value of the first computer system is 1200 W, the total maximum output power value of the remaining PSU or PSUs that operate normally (e.g., the maximum output power value of the second PSU 42 in this embodiment) is 1000 W, and the predefined normal power consumption limit of the CPU 1 is 600 W, the power differential would be 1000 W−1200 W=−200 W (i.e., an excess of the maximum power consumption value of the first computer system over the total maximum output power value of the remaining PSU or PSUs that operate normally is 200 W), and the updated power consumption limit would be 600 W+ (−200 W)=400 W. If the power differential is not smaller than zero, which means that the remaining PSU or PSUs are capable of supplying power to the first computer system that operates at the maximum power consumption value, it is not necessary to compute the updated power consumption limit, and the BMC 21 may cause the CPLD 22 to change the throttling signal from the throttling state to the non-throttling state, so that the CPU 1 operates under restriction of the predefined normal power consumption limit.

In a third implementation of computing the updated power consumption limit, which is similar to the second implementation, the first computer system further has a predetermined buffer value stored in the non-volatile memory component. When the power differential is smaller than zero, the BMC 21 obtains the updated power consumption limit by, in addition to adding up the power differential and the predefined normal power consumption limit of the CPU 1, subtracting the predetermined buffer value from the sum of the power differential and the predefined normal power consumption limit of the CPU 1. The predetermined buffer value is a positive value and is used to preserve flexibility for variation in power consumption of the first computer system, so the first computer system can operate under restriction of the updated power consumption limit safely, thereby protecting the remaining PSU(s). For instance, in a case where the maximum power consumption value of the first computer system is 1200 W, the total maximum output power value of the remaining PSU or PSUs that operate normally (e.g., the maximum output power value of the second PSU 42 in this embodiment) is 1000 W, the predefined normal power consumption limit of the CPU 1 is 600 W, and the predetermined buffer value is 150 W, the power differential would be 1000 W−1200 W=−200 W, and the updated power consumption limit would be 600 W+(−200 W)−150 W=250 W.

In step S4, when the BIOS 3 receives the updated power consumption limit from the BMC 21, the BIOS 3 outputs a system management interrupt (SMI) to the CPU 1, and writes the updated power consumption limit into a model-specific register (MSR) of the CPU 1 to replace an original value (e.g., equal to the predefined normal power consumption limit) stored in the MSR. In one example, the updated power consumption limit is written into an address of 610h in the MSR, named PACKAGE_RAPL_LIMIT [0:14], which has a resolution of ⅛ watts. The resolution of ⅛ watts means that, for example, when PACKAGE_RAPL_LIMIT [0:14]=0x3e8 (in hexadecimal)=1000 (in decimal), the power consumption limit stored in the MSR is 1000 W/8=125 W.

In step S5, after the updated power consumption limit has been written into the MSR, the BIOS 3 sends a notification to the BMC 21, causing the BMC 21 to notify the CPLD 22 to change the throttling signal from the throttling state to the non-throttling state, so that the CPU 1 operates under restriction of the updated power consumption limit (i.e., operating in a reduced power consumption state, such as 250 W in the example given in the third implementation of computing the updated power consumption limit) according to the MSR.

In step S6, when the first PSU 41 is released from the predefined abnormal condition (i.e., returning to normal operation), the first PSU 41 changes the alert signal sent thereby from the alert state to the non-alert state, causing the CPLD 22 to notify the BMC 21 of the change of the alert signal, and the flow goes to step S7. In some embodiments, when detecting the change of the alert signal sent by the first PSU 41, the CPLD 22 causes the BMC 21 to monitor operation of each of the PSUs 41, 42 (e.g., a power supplying condition, such as a magnitude of output power). When the BMC 21 determines that none of the PSUs 41, 42 operates in the predefined abnormal condition or that the first PSU 41 has been released from the predefined abnormal condition, the flow goes to step S7.

In step S7, the BMC 21 notifies the BIOS 3 to send another system management interrupt to the CPU 1, and to write the predefined normal power consumption limit of the CPU 1 into the MSR of the CPU 1, so that the CPU 1 operates under restriction of the predefined normal power consumption limit according to the MSR.

In this embodiment, the first computer system includes one CPU 1, but in other embodiments, the first computer system may include multiple CPUs, as long as the total power consumption of the CPUs comply with the updated power consumption limit computed in step S3 when one of the PSUs operates abnormally. In some embodiments, the functions performed by the CPLD 22 may be integrated into the BMC 21, so it may be possible that the control unit 2 includes only the BMC 21, with the CPLD 22 being omitted.

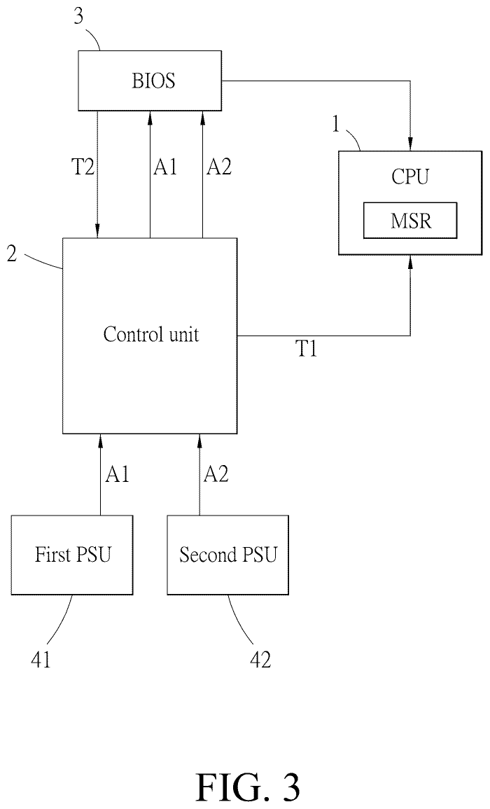

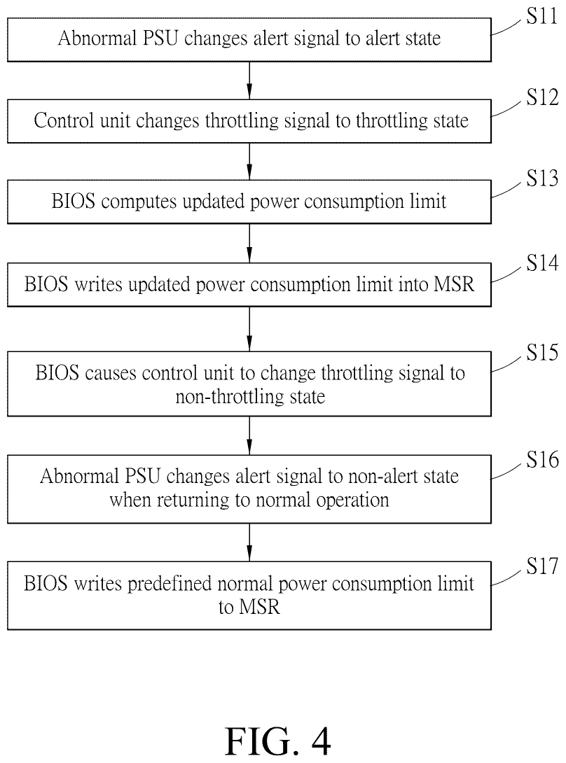

Referring to FIGS. 3 and 4, a second embodiment of a power management method according to this disclosure is adapted for a second computer system that is similar to the first computer system. The second computer system differs from the first computer system in that, in the second computer system, the control unit 2 includes a logic circuit unit that is configured to determine a state of the throttling signal T1, and the non-volatile memory component is accessible to the BIOS 3. The logic circuit unit receives the alert signals A1, A2 respectively from the PSUs 41, 42, receives a notification signal T2 from the BIOS 3, determines the state of the throttling signal T1 based on the alert signals A1, A2 and the notification signal T2, sends the alert signals A1, A2 to the BIOS 3, and sends the throttling signal T1 to the CPU1. The notification signal T2 may be in a notification state (e.g., logic 1 or logic 0) or a non-notification state (e.g., logic 0 or logic 1, which is different from the notification state), and the notification signal T2 represents that the MSR stores the updated power consumption limit when in the notification state. The logic circuit unit is configured to perform logic operations to generate the throttling signal T1 in such a way that the throttling signal T1 is in the non-throttling state when each of the alert signals A1, A2 received from the PSUs 41, 42 is in the non-alert state and the notification signal T2 is in the non-notification state, that the throttling signal T1 is in the throttling state when any of the alert signals A1, A2 received from the PSUs 41, 42 is in the alert state and the notification signal T2 is in the non-notification state, and that the throttling signal T1 is in the non-throttling state when the notification signal T2 is in the notification state.

The second embodiment of the power management method includes steps S11-S17, where steps S11, S14 and S16 are the same as steps S1, S4 and S6 of the first embodiment (see FIG. 2), and thus descriptions thereof are not repeated herein for the sake of brevity. Similarly, the first PSU 41 is exemplified to be the one of the PSUs that operates in the predefined abnormal condition hereinafter for ease of explanation.

In step S12, when the alert signal A1 is in the alert state and the notification signal T2 is in the non-notification state, the control unit 2 changes the throttling signal T1 from the non-throttling state to the throttling state, so as to make the CPU 1 operate under restriction of the predefined lowest power consumption limit (i.e., operating in the throttling state).

In step S13, the BIOS 3 computes the updated power consumption limit based on one of the maximum output power value of the first PSU 41 and the total maximum output power value of the PSU(s) other than the first PSU 41 (i.e., the second PSU 42 in this embodiment). The methods of computing the updated power consumption limit introduced for the first embodiment may be applied to the second embodiment, and are not repeated herein for the sake of brevity, taking note that it is the BIOS 3 that performs the computation in the second embodiment, rather than the BMC 21 (see FIG. 1), as in the first embodiment.

In step S15, the BIOS 3 changes the notification signal T2 from the non-notification state to the notification state, causing the control unit 2 to change the throttling signal T1 from the throttling state to the non-throttling state, so that the CPU 1 operates under restriction of the updated power consumption limit (i.e., the reduced power consumption state).

In step S17, when determining that each of the alert signals A1, A2 is in the non-alert state, the BIOS 3 outputs a system management interrupt to the CPU 1, writes the predefined normal power consumption limit of the CPU 1 into the MSR, and changes the notification signal T2 from the notification state to the non-notification state.

In summary, the control unit 2 detects the alert signals received from the first and second PSUs 41, 42, and controls the CPU 1 to operate in the throttling state in time through the throttling signal when any one of the first and second PSUs 41, 42 operates in the predefined abnormal condition. Then, the control unit 2 or the BIOS 3 computes the updated power consumption limit, which is then written into the MSR of the CPU 1, so the CPU 1 is controlled through the throttling signal to operate in the reduced power consumption state, where the updated power consumption limit is greater than the predefined lowest power consumption limit, thereby preventing the CPU 1 from operating in the throttling state for an unnecessarily long period of time, and the CPU 1 can work more flexibly. When the PSU with abnormal operation resumes normal operation (i.e., being released from the predefined abnormal condition), the BIOS 3 writes the predefined normal power consumption limit of the CPU 1 back into the MSR, so that the CPU 1 can return to operating in a normal operation mode.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A power management method adapted for a computer system that includes a central processing unit (CPU), a control unit, a basic input/output system (BIOS), and multiple power supply units (PSUs) that include a first PSU, said power management method comprising steps of:
A) when the first PSU operates in a predefined abnormal condition, the first PSU changing an alert signal, which is sent by the first PSU to the control unit, from a non-alert state to an alert state;
B) when detecting the change of the alert signal from the non-alert state to the alert state, the control unit changing a throttling signal, which is sent by the control unit to the CPU, from a non-throttling state to a throttling state, so that the CPU operates under restriction of a predefined lowest power consumption limit;
C) when detecting the change of the alert signal from the non-alert state to the alert state, the control unit computing and sending, based on one of a maximum output power value of the first PSU and a total maximum output power value of the PSU(s) other than the first PSU, an updated power consumption limit that is greater than the predefined lowest power consumption limit to the BIOS;
D) when receiving the updated power consumption limit, the BIOS outputting a first system management interrupt to the CPU, and writing the updated power consumption limit into a model-specific register of the CPU; and
E) after step D), the BIOS notifying the control unit to change the throttling signal from the throttling state to the non-throttling state, so that the CPU operates under restriction of the updated power consumption limit according to the model-specific register.

2. The power management method as claimed in claim 1, wherein, in step C), the control unit determines a power differential based on the maximum output power value of the first PSU, and subtracts the power differential from a predefined normal power consumption limit of the CPU to obtain the updated power consumption limit.

3. The power management method as claimed in claim 1, wherein, in step C), the control unit subtracts a maximum power consumption value of the computer system from the total maximum output power value of the PSU(s) other than the first PSU to obtain a power differential, and adds up the power differential and a predefined normal power consumption limit of the CPU to obtain the updated power consumption limit when the power differential is smaller than zero.

4. The power management method as claimed in claim 1, wherein, in step C), the control unit subtracts a maximum power consumption value of the computer system from the total maximum output power value of the PSU(s) other than the first PSU to obtain a power differential, and subtracts a predetermined buffer value from a sum of the power differential and a predefined normal power consumption limit of the CPU to obtain the updated power consumption limit when the power differential is smaller than zero.

5. The power management method as claimed in claim 1, wherein the control unit is a baseboard management controller (BMC).

6. The power management method as claimed in claim 1, wherein the control unit includes a baseboard management controller (BMC) and a complex programmable logic device (CPLD);
wherein the alert signal is sent to the CPLD, and the throttling signal is sent by the CPLD to the CPU;
wherein step B) includes the CPLD notifying the BMC that the alert signal has changed from the non-alert state to the alert state;
wherein, in step C), the BMC computes and sends the updated power consumption limit to the BIOS upon being notified that the alert signal has changed from the non-alert state to the alert state; and
wherein step E) includes the BIOS sending a notification to the BMC, thereby causing the BMC to notify the CPLD to change the throttling signal from the throttling state to the non-throttling state.

7. The power management method as claimed in claim 1, further comprising, after step E), steps of:
F) the first PSU changing the alert signal from the alert state to the non-alert state when the first PSU is released from the predefined abnormal condition; and
G) when detecting that the alert signal sent by the first PSU has changed from the alert state to the non-alert state, the control unit notifying the BIOS to send a second system management interrupt to the CPU, and to write a predefined normal power consumption limit into the model-specific register of the CPU.

8. The power management method as claimed in claim 7, wherein the control unit includes a baseboard management controller (BMC) and a complex programmable logic device (CPLD), and the alert signal is sent to the CPLD;
wherein, in step G), when detecting that the alert signal sent by the first PSU has changed from the alert state to the non-alert state, the CPLD notifies the BMC of the change of the alert signal sent by the first PSU, so that the BMC notifies the BIOS to send the second system management interrupt to the CPU, and to write the predefined normal power consumption limit into the model-specific register of the CPU.

9. The power management method as claimed in claim 1, further comprising, after step E), steps of:
F) the first PSU changing the alert signal from the alert state to the non-alert state when the first PSU is released from the predefined abnormal condition; and
G) when detecting that the alert signal sent by the first PSU has changed from the alert state to the non-alert state, the control unit monitoring operation of each of the PSUs, and, when determining that none of the PSUs operates in the predefined abnormal condition, notifying the BIOS to send a second system management interrupt to the CPU, and to write a predefined normal power consumption limit into the model-specific register of the CPU.

10. The power management method as claimed in claim 9, wherein the control unit includes a baseboard management controller (BMC) and a complex programmable logic device (CPLD), and the alert signal is sent to the CPLD;
wherein, in step G), when detecting that the alert signal sent by the first PSU has changed from the alert state to the non-alert state, the CPLD causes the BMC to monitor the operation of each of the PSUs; and
wherein, in step G), when determining that none of the PSUs operates in the predefined abnormal condition, the BMC notifies the BIOS to send the second system management interrupt to the CPU, and to write the predefined normal power consumption limit into the model-specific register of the CPU.

11. A power management method adapted for a computer system that includes a central processing unit (CPU), a control unit, a basic input/output system (BIOS), and multiple power supply units (PSUs) that include a first PSU, each of the PSUs sending an alert signal to the control unit and the BIOS, said power management method comprising steps of:
A) when the first PSU operates in a predefined abnormal condition, the first PSU changing the alert signal sent thereby from a non-alert state to an alert state;
B) when detecting the change of the alert signal sent by the first PSU from the non-alert state to the alert state, the control unit changing a throttling signal, which is sent by the control unit to the CPU, from a non-throttling state to a throttling state, so that the CPU operates under restrictions of a predefined lowest power consumption limit;
C) when detecting the change of the alert signal sent by the first PSU from the non-alert state to the alert state, the BIOS computing, based on one of a maximum output power value of the first PSU and a total maximum output power value of the PSU(s) other than the first PSU, an updated power consumption limit that is greater than the predefined lowest power consumption limit to the BIOS;
D) the BIOS outputting a first system management interrupt to the CPU, and writing the updated power consumption limit into a model-specific register of the CPU; and
E) after step D), the BIOS changing a notification signal, which is sent by the BIOS to the control unit, from a non-notification state to a notification state, so that the control unit changes the throttling signal from the throttling state to the non-throttling state, and that the CPU operates under restriction of the updated power consumption limit according to the model-specific register.

12. The power management method as claimed in claim 11, wherein, in step C), the BIOS determines a power differential based on the maximum output power value of the first PSU, and subtracts the power differential from a predefined normal power consumption limit of the CPU to obtain the updated power consumption limit.

13. The power management method as claimed in claim 11, wherein, in step C), the BIOS subtracts a maximum power consumption value of the computer system from the total maximum output power value of the PSU(s) other than the first PSU to obtain a power differential, and adds up the power differential and a predefined normal power consumption limit of the CPU to obtain the updated power consumption limit when the power differential is smaller than zero.

14. The power management method as claimed in claim 11, wherein, in step C), the BIOS subtracts a maximum power consumption value of the computer system from the total maximum output power value of the PSU(s) other than the first PSU to obtain a power differential, and subtracts a predetermined buffer value from a sum of the power differential and a predefined normal power consumption limit of the CPU to obtain the updated power consumption limit when the power differential is smaller than zero.

15. The power management method as claimed in claim 11, wherein the control unit includes a logic circuit unit that is disposed to receive the alert signal from each of the PSUs and the notification signal from the BIOS, and that is configured to perform logic operations to generate the throttling signal in such a way that the throttling signal is in the non-throttling state when each of the alert signals received from the PSUs is in the non-alert state and the notification signal is in the non-notification state, that the throttling signal is in the throttling state when any of the alert signals received from the PSUs is in the alert state and the notification signal is in the non-notification state, and that the throttling signal is in the non-throttling state when the notification signal is in the notification state.

16. The power management method as claimed in claim 11, further comprising, after step E), steps of:
F) the first PSU changing the alert signal sent thereby from the alert state to the non-alert state when the first PSU is released from the predefined abnormal condition; and
G) when detecting that the alert signal sent by the first PSU has changed from the alert state to the non-alert state and that each of the alert signals sent by the PSUs is in the non-alert state, the BIOS sending a second system management interrupt to the CPU, and writing a predefined normal power consumption limit into the model-specific register of the CPU.
